(19) United States
(12) Patent Application Publication
(10) Pub. No.: US 2006/0154710 A1
(43) Pub. Date: Jul. 13, 2006

(54) Method and device for continuing an electronic multi-player game, in case of an absence of a player of said game

(75) Inventor: Reza Serafat, Bochum (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 10/538,258

(22) PCT Filed: Dec. 10, 2002
(86) PCT No.: PCT/IB02/05235

§ 371 Date: Jun. 9, 2005

(51) Int. Cl. A63F 13/00

(52) U.S. Cl. 463/1; 463/29

(57) ABSTRACT

The present invention is related to a method and device for continuing and simulating an electronic multi-player game, i.e. an electronic game that involves more than one player or participant, if one of the players leaves the game. The invention is for special use in the field of mobile terminal devices, communication networks such as the internet and other mobile networks. The method for continuing a multi-player game in case of an absence of a player participating in the game comprises running a multi player game application receiving an indication that the player taking part in the multi-player game is absent, and continuing the game by simulating the participation of the player who is actually absent. So it is possible to continue a multi-player game, if one of the game partners intends to pause or to leave the game party.

The invention is related to a method and a device for continuing and simulating an electronic multi-player game, i.e. an electronic game that involves more than one player or participant, if one of said players leaves the game. The invention is for special use in the field of mobile terminal devices, communication networks such as the internet and other mobile networks.

Most multi-player games, such as e.g. skat, two player games such as “pong” (the first tennis simulator) or the like, especially those with only two involved game partners, have to be interrupted or even terminated, if one of the game partners intents to pause or to leave the game party. In such cases the at least one remaining game partner, who might be able to continue the game also has to pause or terminate the game.

In normal cases the game has to be interrupted or even terminated. Some game applications allow to store the game status, so that the game partners are allowed to continue the game later at the same status. The game partner, however, have to interrupt the game anyway, especially if the game relies on only two game partners.

Electronic games have become a widespread entertainment feature and are well known in the state of the art as video games or gaming machines. To increase the fun of the game many video games offer the option to play against a computer or against other persons. Some games can be played in a one, two or more player mode, to provide virtual adventures, or to economize expensive gaming equipment. There are actually many different gaming simulations such as sports games, car races, strategy games and even war games available. The attraction of some of said games resides in the fact that the games can be played via networks such as the internet, enabling remote players to access and play different games against each other, while being in different rooms, homes, towns, countries or even continents.

Such games are e.g. disclosed in the European Patent Applications EP 1 066 868 and EP 1 066 867. The document EP 1 066 868 discloses a “Multi-player game system using mobile telephone and game units”. The disclosed game structure is played via links provided by low power radio connections.

The document EP 1 066 867 discloses a method and an apparatus for playing games between the clients of entities at different locations”. It discloses a method and devices for executing network-based multi-player games.

One drawback of the above network-based remote games resides in the fact that the used wireless connections may be unreliable due to external conditions such as interference, multi-path reflections or other radio transmission characteristics. So it can happen that a game is interrupted or delayed due to data transmission failure.

Most of the modern multiparty games include also an artificial intelligent engine, which allows the user to play against the machine, if no real game partner is available. One of the most common artificial intelligent engines is e.g. the chess engine, which allows the user to play a party chess against the intelligent device. Hitherto the player has to decide at the beginning of the party, to play against a live game partner or against the machine.

In case of playing a multi-party game together with a game partner, it is not possible to continue the game, if the game partner wants to pause, interrupt or to terminate the game.

One drawback of the above scenario is that especially in case of remote players competing via a network it is very likely that one or more players temporarily have to leave the game, during the playtime of the game. In case the user has to leave the game permanently, it can be assumed that the remaining player (if only one is left) wins. Even this victory may be an annoying experience if in the heat of the game the last man playing is automatically declared to be the winner, without even having finished a running action. In case of an electronic monopoly with playing times up to a few hours such a given victory may be unsatisfying.

All the above approaches for multi-player games have in common that they do not provide a suitable option to finish an electronic game in a fair manner if one of the players becomes absent.

It is therefore desirable to provide a possibility to terminate a game in a sportsman like manner, without the need of an unmerited victory.

It is therefore desirable to provide the possibility to continue a game even in the absence of a player, without the need to interrupt the game itself.

In case of network based multi-player games it is further desirable to have a “failsafe” option to continue the game even, if the connection to other players or a game server is temporarily or permanently interrupted.

According to a first aspect of the present invention, there is provided a method for continuing an electronic multi-player game. The method comprises the steps of: running an electronic multi player game application, receiving an indication that one of the players is actually absent. The method is characterized by simulating the (fictive) participation of said absent player in the running game.

The operation of a multi-player game application and the reception of an indication that a participant or player taking part in said multi-player game is or is going to be absent is known in the state of the art of electronic games. The indication of the absence is usually performed by pressing a “Pause” key on the gaming device, which can be followed by an interruption or an ending of the game. The ending may be a necessary result as the game is a multi-player game and the number of remaining players may not be sufficient to regularly play the game to an end.

The method of the invention is characterized by simulating the participation of said absent player by preferably simulating the actions and moves of said absent player.

The present invention provides a method and a device to avoid the interruption or termination of a multi-party game, if one (or more) of the participants wants to leave or has to leave the game party. In most of the multiparty games, especially those based on two-players games, the game has to be interrupted or even terminated, if a game partner cannot continue to play the game, or another person can be found to take the place of the leaving player. This inconvenient result may be avoided, if the game application includes also an artificial intelligence engine that can take over the role of the game partner, who wants to interrupt or leave the game.

The interruption can be easily circumvented, if the game application includes an artificial intelligent engine that can take over the role of the game partner, who wants to leave the game party. For this purpose the game user interface can present a message to the remaining game partners who are able to continue the game and can ask them, if it is desired to continue the game. If the answer is yes, the game application can trigger directly the artificial intelligence engine of the game. The artificial intelligence engine can then read the current game status from the internal game state register of the game application and replace the game partner, who interrupted the game. It is also possible to consider a corresponding entry in the game configuration option so that the user can enable the automatic game continuation, if one game partner leaves the game party. In this way the game can be continued seamlessly.

In one example embodiment said multi-player game is a network based multi-player game. The present invention is especially useful in online or network based games, as the communication between the players is strongly restricted to the game itself. There is no easy way to communicate the fact that one of the players wants to quit the game, compared to the standard scenario with two or more players in a single room and the option to postpone a running game. Another drawback of network based games resides in the connection between the players. During the game it can happen that the connection between the players is disturbed or interrupted resulting in an interruption or in a stop of the game. It would therefore be very useful to have an option to go on playing without any interruption even if the connection between the players is temporarily disturbed.

In another example embodiment, the method further comprises monitoring the inputs the players of the multi player game, analyzing said inputs to determine the gaming characteristics of said players and simulating the game and gaming behavior of the absent players in accordance with said determined gaming characteristics.

By monitoring the inputs of at least one participant of said multi-player game, while the player is still participating in said game, it can easily be determined how probable it is that the player is going to win or loose the game. By analyzing said inputs according to game specific parameters the gaming characteristics of said at least one monitored player can be determined. In accordance with the actually used game parameters such as accuracy, performance, strategies and preferred key combinations this behavior can be individually determined for each of the participants. With this parameters the participation of the absent player can be simulated in a very lifelike manner in correspondence with said determined gaming characteristics.

By using such an enhanced simulation it can be assured that the remaining players will not notice the change in the game. By enhancing e.g. the simulation in such an adaptive way, it can be assured that the final result represents the most probable final result.

In another example embodiment of the present invention, the method further comprises the determination of a result of said game based on said determined gaming characteristics of said at least one monitored player. Thereby the final result can be extrapolated from previous gaming characteristics. By considering said determined gaming characteristics and the previous game, the game can be terminated with at least a very probable final result.

The final result can be calculated e.g. by determining the actual scores and e.g. a determined strengths of the play of the individual gaming partners to determine a probable result very fast. It is even possible to simulate a “fast forward” button, wherein all participants of the running game are simulated in a fast match, to quickly extrapolate the most probable final result. This fast forward option can be used to simulate the rest of the game in a time lapse manner, so the players can watch or observe the rest of the game in “high speed”. Such a “fast forward” option can also deliver a more gentle termination of said game with a transition period between an active participation via a passive following of the game to the final termination with an extrapolated final result.

In another example embodiment said method further comprises transferring said determined gaming characteristics to another gaming device. According to the above usage scenarios, the game is played e.g. in a single video game or via a central game server. The central game server has the advantage that the server can use great computation resources without the need to save battery power. A drawback resides however in the fact that the game server has to manage or monitor all players simultaneously. It might therefore be simpler for each of the gaming devices in a network to simply determine the actual gaming characteristics of only the respective player and to transmit the gaming characteristics together with a notification of an imminent absence. One of the drawbacks of this procedure is that this data transfer has to be standardized.

In another example embodiment of the present invention said indication indicative of the absence of a player comprises a notification received from said absent player. Thereby, a player can notify the other players about his intention to leave the game. The indication can also comprise the notification of a network that the connection to one of said players is actually disturbed or interrupted.

In another example embodiment of the present invention said method further comprises the transmission of a notification to at least one of said other participants of said multi-player game, wherein said notification comprises an information that a participant is actually simulated. Thereby it can be assured that every player is actually aware of the proceedings of the game. The single players can thereby decide by themselves if they want to play a partially simulated game to an end or if a partially or purely simulated game may be considered as an unattractive solution.

In yet another example embodiment of the present invention said method further comprises the interruption of said game, if all participants are absent. Thereby it can be prevented that a server wastes resources by playing completely simulated games. If said feature is disabled the simulation can be used to determine typical characteristics of the electronic game, wherein a machine simulating a virtual player is interacting with a virtual game. Having this option disabled the fully simulated game may be used as a kind of screen saver for computer devices, showing much more action than the standard “star-flight” simulation. Thereby an animated “ant-farm” of an animated aquarium may be implemented.

In another example embodiment the method further comprises the termination of said simulation, if an absent participant returns to the game. This corresponds to a player re-joining the game party after a break. It is clear, that for multi player games, the probability of an interruption increases with the number of participating players. So the more players a game requires, the more probable an interruption due to breaks of single players gets. It is therefore clear that a game benefits from the invention the more players are required for playing said game.

According to yet another aspect of the invention, a software tool is provided comprising program code means for carrying out the method of the preceding description when said program product is run on a computer or on a network device.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer or a network device.

According to yet another aspect of the present invention a multi-player gaming device for continuing a multi-player game, if a participant in said game becomes absent, is provided. The multi-player gaming device comprises a memory, a processor, at least two interfaces, a detector and a simulation component. This gaming device may be embodied as a resident fixed line telephone or may be a mobile terminal device equipped with such a feature.

The memory, the processor, the at least two interfaces are standard components of conventional electronic multi-player games. The memory is used to store and to access the data of a game application. Such electronic games are known in the state of the art. The interfaces are usually provided to exchange game data with players or with other connected gaming devices, to provide the multi-player game option. Nowadays the multi player gaming devices are small computers, wherein a processor is connected to said memory and is further configured to run a multi-player game program. The configuration is usually done via a software received from said memory. The at least two interfaces are connected to said processor, said interfaces being configured to exchange game data, i.e. usually an opto-acoustical signal such as e.g. a composite video signal as used for televisions, a RGB/audio signal as it can be used for computer monitors or built in displays and the like.

The gaming device is characterized by a detector and a simulation component. The detector is used to detect an indication that a participant of said multi-player game is absent. This indication can be detected as e.g. an interrupted connection to a player interface, or a signal from a player that he wants to quit the game. The indication can be detected directly, if e.g. the connection to a controller such as a joystick, a joypad or the like (a player input interface) is disturbed or interrupted, a pause key is pressed (e.g. only on one of said controllers) or a connection to a remote player/gaming device is interrupted.

Said simulation component being connected to said processor. Said simulation component is further configured to simulate the participation of an absent player in the game. The basic idea is to continue the game by pretending that the absent player is still present. Therefore the interactions of the player with the game are simulated by an electronic component, if said absence indication has been received.

In another example embodiment of the present invention said multi-player gaming device further comprises a network interface. Basically, the network interface is intended to enable a network based game to interact with remote players via said network. The network interface can also be used to access game data and download new games. The network interface can be a wired or a wireless network interface. The interface can e.g. be an interface to a local area or to a wide area network.

In an additional example embodiment, said multi-player gaming device comprises a mobile telephone. The present invention is useful when applied in mobile telephones for multi-player games that are played via wireless connections, which may become interrupted due to radio interference such as multi-path reflection. Additionally, especially in the case of mobile phones it is very probable that a running game is interrupted by an incoming telephone call. The application of the present invention in mobile telephones is very useful, as an incoming phone call does not automatically interrupt a running network game.

In another example embodiment of the present invention said processor or said simulation component comprises an artificial intelligence engine. An artificial intelligence engine is usually provided in an electronic gaming device to provide a single player mode, wherein the player can compete against the computer. In the present invention the artificial intelligence engine is used to simulate the participation of the absent player. More sophisticated approaches to implement the invention can also comprise a player characteristics evaluation component, which is adapted to determine the characteristics of the play of an individual player and to use these characteristics to improve the simulation of the participation of the absent player.

According to another aspect of the present invention a multi-player game network server is provided that is capable of continuing a multi-player game, if a player in said game becomes absent. The server comprises a memory, a processor, at least one interface, a detector and a simulation component.

The memory, the processor and the interface are the standard components of a multi player game server, known in the art. The processor is connected to said interface and to said memory. The processor is configured to run a multi-player game program or a multi player game application. The interface is configured to exchange game data with players connected to the server via said network, as known in the state of the art.

The multi-player game server according to the present invention is characterized by a detector and a simulation component. The detector is provided to detect an indication that a player of said multi-player game is absent. Said detector can be implemented in said processor or can be implemented in said interface device. The detector is to detect that a player is no longer participating in said game. Said detector is connected to said processor or said simulation component to start a simulation simulating the participation of said absent player in said game, so that it is not necessary to interrupt the running game, if one of the players quits or looses a contact to the server.

The simulation component can be embodied as an artificial intelligence engine that helps to implement a seamless continuation of the game proceeding, if some game partners want to interrupt or leave the game party or becomes absent. The artificial intelligence engine can also substitute more than only one single game partner and enable the game continuation as long as at least one real player is present.

It is to be noted that in the preceding specification only the case of one player leaving the game party is described. It is clear that the disclosed methods and procedures can be repeated if another game partner or more than one of the game partners are leaving the game party, in a similar manner.

It is further to be noted that the present invention may also be used in the opposite direction. That is a user playing a game in a single player mode against a virtual competitor, may handover the score of his virtual competitor to a real player. In case of a simple video game this implementation should be relative easy to be implemented e.g. via the pause menu and a respective handover feature. In case of a multi-player online game or network game the required data exchanges for synchronizing two gaming devices and the handover protocols have to be developed and can use any kind of appropriate protocol or programming language in correspondence with the actually used communication network.

In the following, the invention will be described in detail by referring to the enclosed drawings in which:

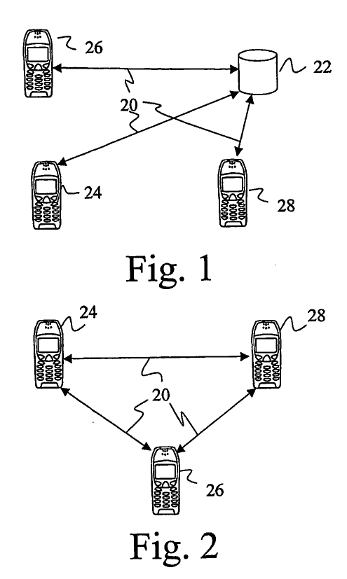

FIG. 1 shows a network based multi-player game having a star topology,

FIG. 2 shows a network based multi-player game having an interwoven topology,

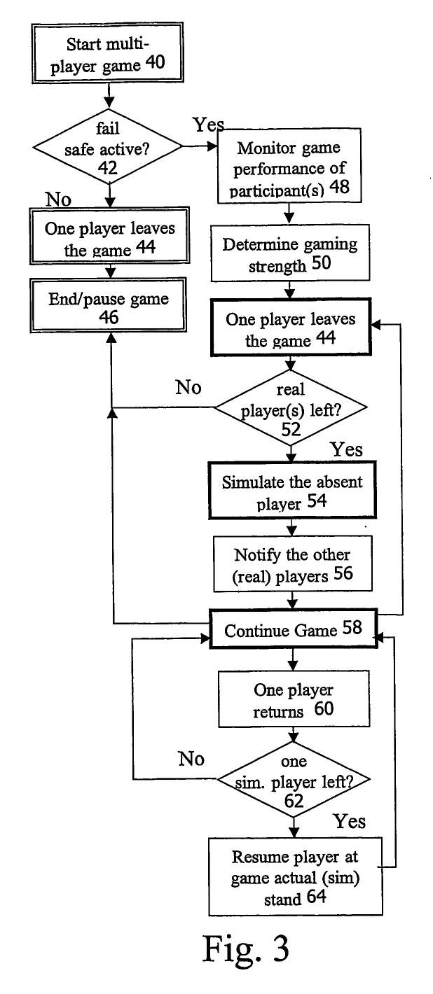

FIG. 3 shows a flow diagram of the method according to one aspect of the present invention, and

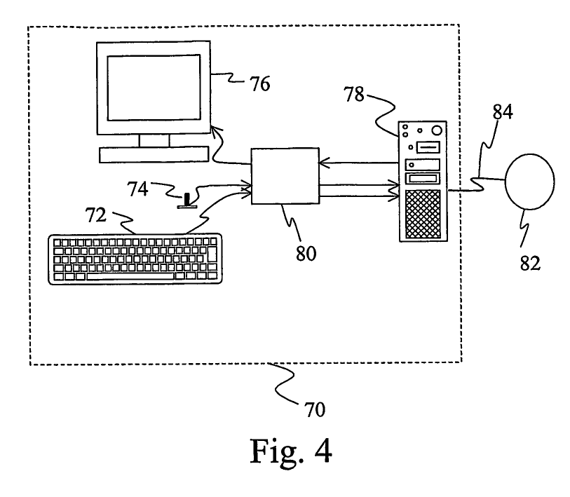

FIG. 4 shows one embodiment of a gaming device according to one aspect of the present invention.

FIG. 1 shows the conventional star topology of an electronic multi-player game. The star topology comprises a number of interface devices 24, 26, 26 and a central gaming server 22. According to different embodiments this topology can be embodied as shown as a number of game enabled phones being connected 20 via telephone or short range radio to a central game server device 22. In case the interface devices 24, 26, 28 are computers and the communication lines 20 are e.g. the internet network the game server 22 is a centralized internet game server. In the simplest case, the interface devices are the game controllers of a video game. The star topology is based on the idea that a single simulation is running in one place and the interface devices exchange just the moves of the players and are not running a simulation itself. The star topology is characterized by a single processor running a single game or simulation program. In case one of the connections to the interface device is interrupted, the respective interface device can not continue the game. The star topology corresponds to a hierarchical structure, wherein one of said devices is the master and the interface devices are the slaves.

The presented usage case relates to a multi party game offered and arranged e.g. on a network like the Internet. The network is having a star topology. The actual game logic and an intelligent component is located in the server 22 which controls the game flow and ensures the data exchange 20 between different game partners 24, 26, 28. The server 22 controls also the availability of the participants and the handshaking procedure, when a new gaming partner (not shown) is going to join the game or even would like to leave the game round. The server controls also the status of connection of the clients (mobile gaming users). If one client gets out of coverage or range (temporarily or permanently) the server can recognize it within a reasonable time period. This time period will of course depend on the type of the game. Turn-by-turn games like e.g. chess can tolerate a longer period in comparison with fast shooting or jump and run games.

According to the invention the server 22 can take over the roles of gaming partners 24, 26, 28 in different situations. In the following, there are illustrated some of such scenarios:

If one of the game partners, e.g. 24 would like to leave the game round, the game partner has to send a message to the game server 22 indicating the intention to lave or to pause. The game server 22 will then immediately take over the role of the gaming partner 24, who is going to leave or pause. For this purpose an instance of an artificial intelligence engine of the server 22 can be activated automatically. This instance plays against other game partners 26, 28 so that they cannot recognize the fact that one of the team mates or the other players has left the game.

In addition to that the server 22 can check the availability of the game partners 24, 26, 28 by testing their connection periodically. If one of the users or game devices 24, 26, 28 loses the connection 20 caused by some reasons (e.g. no coverage temporarily), the server 22 will then takeover the role of the lost gaming partner automatically. If the gaming partner returns back the round, it has first to register itself to the server 22. The server 22 will then check, if it is possible to hand over the game party back to the returned user. If yes, it will send the latest game status to the user and handover the game back to him.

Another usage scenario deals with multi party games initiated by one mobile gaming partner using a wireless communication means for game data exchange purposes. The wireless means could be Bluetooth, GPRS (general packet radio service), UMTS (Universal Mobile Telephone Standard), Wireless LAN (Local Area Network), infra red and the like. No matter which connectivity means is used for such a gaming party, one of the game partner has to act as a server and control the data exchange between different partners. The gaming device acting as server 22 for such game, will play the same role as the network based (centralized) server 22, described in the above paragraph. However, here are some additional aspects that should be taken into account.

One important scenario is the case that the gaming partner whose device acts as the game server 22 wants to leave the party. In this case, it has to handover the server role to one of the other partners. The server device will send an indication to the gaming partner and ask, which one is capable of being a game server for the party. If the device of one of the game partner is able to play the role of game server, the original server will then send the corresponding data to the other device (new server) before leaving the game round so that other game partners can continue the game. The handover of the game server could be seamless. In this case the data exchange will happen between devices without any user interaction. This means that the game engines should have the capability of hidden hand shaking and data exchange procedures. Another option is that a user interaction is needed for handing over the server data. In this case the game partner will pause the game for a short period, while the data exchange is performed.

FIG. 2 shows the conventional interwoven topology of an electronic multi-player game. The star topology comprises a number of interface devices 24, 26, 26 being interconnected. According to different embodiments this topology can be embodied as shown as a number of Game enabled phone devices being interconnected 20 via telephone or short range radio. In difference to the star topology the present interwoven structure is characterized by a distributed game program exchanging the moves between the single interface devices. If the connection is interrupted, the signal exchange is interrupted and the part of the game or the simulation that represents the other players is interrupted. In case of a team play, this interruption may be perceived as disturbing, but in the case of a concurrence game, the interruption may lead to an unfair advantage of one concurrent.

Mixtures of both topologies are also possible, wherein a star topology is extended by star topology sub sections (“Snowflake” structures) or interwoven topology subsections. Alternatively, the interwoven topologies can comprise small star topology sub sections.

All the described topologies have in common, that if a multi-player game with a minimum of required players the number of active players falls below the critical minimum the game is to be interrupted or paused. This is independent of the reason of the decrease of the players. In case of an elimination game, the reached minimum usually defines the end of the game. If the minimum is reached because of an interruption or termination of a player or a connection breakdown, there is actually no way to continue the game in a fair manner.

FIG. 3 shows a flow diagram of one embodiment of a method according to the present invention, to continue a multi-player game, in case that one or more players become absent during the game. The present invention can basically provide a game character “autopilot” for absent players to be able to keep the game running. The present invention can provide a partially virtual game experience with other game partners, by using an artificial intelligence engine to implement a seamless continuation of the game proceeding, if some game partners becomes absent.

The depicted flowchart can basically be divided into three parts, the conventional game part depicted in the double outlined boxes 40, 44 and 46, the part of the basic invention depicted in the bold outlined boxes 44, 54 and 58 and additional step features 42, 48, 50, 52, 56, 60, 62 and 64 depicted in normal outlined boxes. An electronic game is usually based on a start option for a one or multi-player mode. One player modes of electronic games are no subject of the present invention and are therefore not discussed in the following. The electronic game is therefore started in a multi-player mode 40. The multi-player game option is e.g. known as the “vs.” or versus mode of an electronic game. Conventionally, if one of the players leaves the game 44 to carry out some short time actions such as accepting a telephone call, or the like, the game is paused 46 until the return of the player. Alternatively the game is ended, if the player can not return. Such scenarios are well known to anyone playing multi-player electronic games. If the gaming device or the interface device of the game is implemented in a telephone, it is very likely that a user interrupts a running game to accept a phone call. This has the drawback that a remote other player can not easily recognize, that the user is actually pausing and how long this break is going to be. The present invention can e.g. be optionally activated by a “failsafe”-option 42 in the setting menu of the electronic game. The “failsafe” option may also be automatically activated if an online, network or remote game mode is activated. If the reason for the break of one player is e.g. an incoming phone call or a message which the user wants to be displayed, the acceptance of the phone call/message display can lead to the automatic start of the fail safe option. However, the user might have activated the feature in such a way that the gaming device asks for confirmation that the game shall be continued automatically if the user accepts the incoming call or reads the message.

The user might also want to select, whether the artificial intelligent engine shall take over the gaming function in dependency of the kind of message that is received. In case a short message is received, the user may not want to interrupt the game, whereas an incoming phone call may be considered as important enough to interrupt a running game. So the user may be able to select particular phone numbers which actually interrupt the game by activating the artificial intelligence engine and to select particular phone numbers from which incoming calls/messages are ignored if a particular game is running.

The user might also want to choose if the artificial intelligent engine shall take over the gaming function in dependency of the nature of the game and the used type of communication terminal/equipment. If the communication terminal is a standard mobile phone (eg the Nokia 6210) he might activate that the system automatically takes over the game when an incoming call is received, because the user needs to press a dedicated button and put the phone to his head to make the phone call.

If the phone is equipped with a handsfree loudspeaker (as e.g. incorporated in the Nokia 9210 phone) or a headset is connected to the phone which both enable the user to continue the game even during a phone call, the user might select this option. The user might also prefer to continue a party of chess himself, irrespective of any other activities he is doing, but prefers the artificial games engine to continue his part immediately in case of any interruption if a car racing game or similar is played online.

The basic principle of the present invention is shown in the boldly outlined boxes 44, 54 and 58. In the simplest version the boxes 42, 48 and 50 are neglected. If one player leaves the multi-player game or becomes in another way absent, the game starts simulating 54 the absent player and continues the game 58. It is basically like replacing the lost player by an automated one until the game is over, paused 46 or the absent player returns.

In case of a more sophisticated approach, the method for simulating an absent player can further comprise a determination 52 of the number of active non-simulated players in the multi-player game and the termination or the pausing 46 of multi-player game if only simulated game characters are left. Thereby it can be prevented that the simulated game characters keep playing for hours even if no real player is left.

The method can also comprise a notification 56 of the remaining players about the number of actually simulated game characters. This can be embodied with a small game interruption, wherein the players themselves can decide if they want to keep playing with or against a certain number of virtual players. This can for example be embodied as a fractional number indicating the share or the percentage of real or simulated players in the total amount of game characters or players. The human or virtual percentage can be a permanent part of the displayed information on the screen of the electronic game or can be only inserted in the display if the percentage changes. Alternatively, the simulated game characters may change their visual appearance by simulation indicating equipment or color. A simulated character may be fitted with a sash, an antenna, a blinking light, a visibility feature or anything that can indicate that a game character is actually simulated. So for example in a car race, every automatically piloted car can be fitted with a huge antenna, or can be depicted in a semi transparent manner as a “ghost car”.

The method can further comprise an artificial intelligence engine to enhance the quality of the simulation of the player. The artificial intelligence engine can monitor 48 the performance of one or more players to better simulate the individual game characteristics of each player individually. The system can e.g. analyze the individual number of key inputs, the number of successful actions and preferred key combinations, or game strategies. A more sophisticated simulation program can even consider or simulate performance variations, a luckiness factor or even increase the performance by being able to learn. This enhanced simulation can be used to end a game by playing in a very lifelike manner. To further increase the performance of the system and the simulation, the behavior patterns of single players can be monitored over a number of games, even over a number of different games to determine typical behavior patterns and solution approaches. The more games the individual has played, the better the system may use this information to simulate the individual characteristic of each participant in the game.

The method can be used in a simple way to determine a one-dimensional gaming strength by generating a game character that may reach the same performance of the player. In the simplest way, e.g. in a car race an automated car with the same average lap time is simulated. By using a more sophisticated simulation, the average lap times and the average sector and curve speeds can be simulated. In a more sophisticated version of the simulation the average track line and the average variation of the actually or virtually driven track lines can be simulated. The more variables in the behavior pattern of a single user can be determined and simulated, the better and more lifelike the simulation would feel.

In a network based multi-player game based on a star topology, the behavior pattern analysis 48 can also be used to determine the average player, the average playtime and the average difficulty of the game. So the information gathered by observing the players of a centralized network game can be used to improve the next generation of games with respect to variables such as difficulty, playtime, fun, required reaction time, eye movement and story depth. The simulated character can also be used to generate the average player as an instrument to objectively judge the parameters of a video or computer game.

The method to continue a multi-player game if a player becomes absent can also be extended by a re-entering feature for one or more players. In case of e.g. a flight simulation game, the “auto-pilot” can be switched off, if the player returns to the game and resumes at the advanced score. The simulation can be extended in that not only a simulation of a player can be activated if a player becomes absent, but that simulation can also be terminated to enable a returning player to take up the “automatically extended” game. The extension is indicated by the box 60 indicating that one player returns. The “returning” player can be one of the absent players or may act as a replacement for an absent player. The absent player may be indicate by a notification if it is probable that the player is going to return or if his score may be taken over by another player. The simulation may be timer controlled to provide a sure return for e.g. ⅕ to 1/10 of the estimated play time and searching for new players after the time has passed. In case of an “open score” it is checked 62, if a returning or a new player can take over a running simulated game character, by determining the number of simulated characters and if the simulation is still running, resume 64 the game at the actual score of the simulation.

The drawbacks of the state of the art and the need to interrupt or terminate a game can be circumvented, if there is an artificial engine available and the game application is implemented such that the artificial intelligence engine substitutes the game partner if needed as described above. If a player wants to leave the multi player game, there are two options to implement this feature in the box 44:
1) In an interactive approach a player signalizes his intention to interrupt the game to the game partner(s). The game application of the other game partner will get this indication and will present a message to the other game partner(s), who still want(s) to continue the game and reports the intention of the game partner and ask whether the player(s) want(s) to continue the game. If yes, the artificial intelligent engine can be triggered and the game can be preceded from the same state.
2) In an automatic approach, the game includes a dedicated configuration option entry related to the seamless continuation of the game (see box 42). If this option is enabled, the game application ensures the substitution of the leaving gaming partner by the artificial intelligence engine automatically and the game party can be continued seamlessly.

In the simplest case the invention can be implemented in a game software. The invention can also be implemented in a hardware implementation, wherein the moves and actions of a user are analyzed for behavior patterns. A hardware implementation may be connected between an input and an output interface of the gaming device. After sufficient training the player may be analyzed in his reactions to the display output and therefore it should be possible to implement a virtual player “black box” imitating the behavior of a real player.

FIG. 4 shows one embodiment of a gaming device according to one aspect of the present invention. The depicted embodiment shows a gaming device 70 with a gaming processor 80 and player interfaces 72, 74, 76. The gaming device further comprises a connection 84 to other devices 82 such as additional player interfaces, gaming devices or game servers. The user interfaces can comprise e.g. a keyboard or keypad 72, a joystick 74 and a display 76. The gaming device further comprises a central processing unit 78 depicted as a computer. The device according to one embodiment of the present invention further comprises a user interaction analyze and simulation unit 80. The simulation unit 80 can be controlled by the user and the central processing unit 78. In case that the user interacting with a game application that runs on said central processor 78 want to pause the game, the simulation unit 80 can take over the inputs of the user to simulate the moves and the inputs of the user, to keep the game running. In case that the user want to rejoin the game, the user or player simulation unit 80 can be overridden by the user input on the keyboard 72 or the joystick 74. Alternatively, the player simulation unit 80 can be branched on the other side of the central processing unit to simulate the moves and inputs from other players of the multi-player game 82, connected to the central processing unit 78 via the connection 84. If the simulation unit 80 is branched into the connection 84 to other players, the moves of the other players can be simulated and the multi-player game can be finished, even if the connection 84 to the other players/or gaming devices 82 should be interrupted.

It should be noted that the simulation unit 80 may be implemented in the central processing unit 78. The simulation unit 80 can be implemented as a software application running on said central processing unit 78.

It is to be noted that the concepts described in the preceding description assume that in a multi party game at least one device should act as server and control the data flow. This will of course ease the concept implementation and reduce the overhead. However it is not a must. Even in peer-to-peer scenario this kind of seamless hand-over can work. In this case all involved parties have the same role and control level. In this case all involved devices check the availability of other game participants by checking their connections. If one game member looses the connection (e.g. because of coverage loss) the first device, which recognizes the loss of the game member activates its own artificial intelligent engine and ensures the seamless continuity of the game. For this purpose, it sends a broadcast message to other active devices and indicates that it is going to take over the role of the missing game partner. This should avoid possible network collisions. It should further be clear that the expression “multi player gaming device” is used to refer to electronic games being capable of providing entertainment to more than one player, can include the capability of providing games in a one player mode. The present invention is not to be restricted to multi-player-only electronic games.

This application contains the description of implementations and embodiments of the present invention with the help of examples. It will be appreciated by a person skilled in the art that the present invention is not restricted to details of the embodiments presented above and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. A method for continuing a multi-player game in case of an absence of a player participating in said game, said method comprising:
running a multi player game application,
characterized by
receiving an indication that said player taking part in said multi-player game is absent,
continuing the game by simulating the participation of said player who is actually absent.

2. The method according to claim 1, wherein said multi-player game is a network based multi-player game.

3. The method according to claim 1, further comprising:
monitoring the inputs of at least one player of said multi-player game,
analyzing said inputs to determine gaming characteristics of said at least one monitored player, and
simulating the participation of said absent player in correspondence with said determined gaming characteristics.

4. The method according to claim 3, further comprising determining a result of said game based on said determined gaming characteristics of said at least one monitored player.

5. The method according to claim 3, further comprising transferring said determined gaming characteristics to another gaming device.

6. The method according to claim 1, wherein said indication that a player is absent comprises a notification received from said absent player.

7. The method according to claim 1, further comprising sending a notification to at least one of said other players of said multi-player game, said notification comprising an information that the participation of at least one player is actually simulated.

8. The method according to claim 1, further comprising the interruption of said game, if all players are absent.

9. The method according to claim 1, further comprising terminating said simulation of the participation, if said absent player returns to the game.

10. A software tool comprising program code means stored on a computer readable medium for carrying out the method of anyone of claims 1 to 9 claim 1 when said software tool is run on a computer or network device.

11. A computer program product comprising program code means stored on a computer readable medium for carrying out the method of claim 1 when said program product is run on a computer or network device.

12. A computer program product comprising program code, downloadable from a server for carrying out the method of claim 1 when said program product is run on a computer or network device.

13. A computer data signal embodied in a carrier wave and representing a program that instructs a computer to perform the steps of the method of claim 1.

14. A multi-player gaming device for continuing a multi-player game in case of an absence of a player participating in said game, comprising:
a memory,
a processor being connected to said memory, said processor being configured to run a multi-player game program,
at least two interfaces being connected to said processor, said interfaces being configured to exchange game data,
characterized by
a detector to detect an indication that a player of said multi-player game is absent, and
a simulation component being connected to said processor, said simulation component being configured to simulate the participation of an absent player on the game, if said absence indication has been detected.

15. The multi-player gaming device according to claim 14 further comprising a network interface.

16. The multi-player gaming device according to claim 14 further comprising a mobile telephone.

17. The multi-player gaming device according to claim 14, wherein said simulation component comprises an artificial intelligence engine.

18. A network multi-player game server capable of continuing a multi-player game, if a participant in said game becomes absent, comprising:
a memory,
a processor being connected to said memory, said processor being configured to run a multi-player game program,
at least one interface connected to said processor, each said interfaces interface being configured to receive and transmit game data, said network multi-player game server being characterized by
a detector to detect an indication that a player of said multi-player game is absent, and
a simulation component being connected to said processor, said simulation component being configured to simulate the participation of an absent player, if said absence indication has been detected.
